(19) United States
(12) Patent Application Publication
(10) Pub. No.: US 2003/0017818 A1
(43) Pub. Date: Jan. 23, 2003

(54) Circuit intended to generate a substantially constant negative conductance as a function of frequency

(76) Inventors: Sebastien Amiot, St Aubin S/Mer (FR); Bertrand Duloy, Villons-Les-Buissons (FR)

Correspondence Address: Philips Electronics North America Corporation, 580 White Plains Road, Tarrytown, NY, 10591, US

(21) Appl. No.: 10/179,358

(22) Filed: Jun. 25, 2002

(30) Foreign Application Priority Data
Jun. 26, 2001 (FR) 0108419

(51) Int. Cl. H04B 1/26

(52) U.S. Cl. 455/327

(57) ABSTRACT

The present invention relates to a circuit intended to generate a negative conductance NG between two connection terminals A and B, including a first and a second transistor T1 and T2 connected as a differential pair between said connection terminals A and B.

According to the invention such a circuit further includes a first active component T3 arranged between the bias and transfer terminals of the first and the second transistor T1 and T2, respectively, and a second active component T4 arranged between the bias and the transfer terminal of the second and the first transistor T2 and T1, respectively.

The invention permits to generate a negative conductance which has a value that is substantially constant as a function of the operating frequency of the circuit, which circuit can be completely produced in integrated form.

The present invention relates to an electronic circuit intended to generate a negative conductance between two terminals.

Such circuits are often used in association with resonant circuits so as to form oscillators which offer a well-controlled oscillation state. As a matter of fact, a usual resonant circuit comprises passive components, for example, an inductive and a capacitive element coupled in parallel which present an intrinsic positive conductance which, when the oscillator is in the oscillation state, causes losses which tend to reduce the effect of the oscillation state, that is to say, to cause a progressive reduction of the amplitude of signals generated by the oscillator. The negative conductance generated by the electronic circuit associated with the resonant circuit permits to compensate losses and preserve the oscillation state.

An assembly of a resonant circuit associated with a circuit intended to generate a negative conductance is known from pages 27 and 35 of the technical instruction of the circuits TDA6502 and TDA6503 marketed by the applicants, which are integrated mixers/oscillators intended to form part of tuners in audio/video signal receiver sets such as television sets, video recorders or set top boxes.

This assembly includes a first and a second transistor connected as a differential pair and having bias terminals which form connection terminals of the circuit, transfer terminals connected to a supply terminal via load resistances, and reference terminals.

In the known assembly the first and second transistors are bipolar transistors which have a base, collector and an emitter which form their bias, transfer and reference terminal, respectively.

The known assembly further includes a first capacitive element connected between the bias terminal and the transfer terminal of the first and second transistor, respectively, and a second capacitive element connected between the bias terminal and transfer terminal of the second and first transistor, respectively.

The first and second capacitive elements create negative feedback which permits to obtain negative conductance.

The known assembly has the following drawbacks:

Firstly, as the capacitive elements cannot easily be produced in integrated form, their connections to the differential pair which itself is included in an integrated circuit, makes it necessary to provide said integrated circuit with two additional external connection terminals connected to the transfer terminals of the first and the second transistor. The manufacture of these connection terminals brings about additional cost which will be reflected in the total cost price of the integrated circuit which includes the differential pair. Moreover, the capacitive elements themselves generate additional cost for the user of said integrated circuit.

Besides, the effect of the negative feedback produced by the capacitive elements is not constant as a function of the operating frequency of the assembly. This brings about that the value of the negative conductance will be caused to vary as a function of frequency and thus that the losses generated by the intrinsic positive conductance of the resonant circuit included in the oscillator cannot be compensated in a homogeneous way throughout the range of variation of the oscillation frequency, which calls forth a degradation of the spectral purity of the signals generated by the oscillator. This phenomenon is relatively harmless in applications of reception of cable television signals or analog radio waves, but becomes detrimental in applications for digital television signal reception for which the standards impose the presence of 2000 to 8000 different carriers in 8 MHz channels, applications for which it is well understood that the spectral purity of a signal delivered by the oscillator, whose frequency oscillation will determine inside a tuner a carrier frequency to be selected, is crucial.

It is an object of the invention to remedy these drawbacks by proposing an electronic circuit intended to generate between two terminals a negative conductance that has a substantially constant value as a function of the operating frequency of said circuit, which may be completely realized in integrated form.

For this purpose, an electronic circuit intended to generate a negative conductance between two terminals includes according to the invention a first and a second transistor connected as a differential pair and having bias terminals which form the connection terminals of the circuit, transfer terminals connected to a supply terminal via load resistors, and reference terminals, which circuit further includes a first active element arranged between the bias terminal and transfer terminal of the first and the second transistor, respectively, and a second active element arranged between the bias and the transfer terminal of the second and the first transistor, respectively.

The first and second active elements realize a negative feedback which permits to lead a negative current to the bias terminal of that transistor of the differential pair that is the more conducting at a given instant. This negative current permits to generate a negative conductance.

The use of active elements for realizing negative feedback permits to realize the circuit described above entirely in integrated form. The active components having a substantially invariant behavior for wide frequency ranges, the value of the negative conductance generated thanks to the invention will be substantially constant for the whole variation range of the operating frequency of the circuit.

In a particular embodiment of the invention the first and second active elements are formed by junctions included in third and fourth transistors.

In a variant of this embodiment the third and fourth transistors arranged as diodes which permits, by short-circuiting parasitic capacitances present between the transfer and bias terminals of said transistors, to improve the linearity of the circuit and the invariance of the value of the negative conductance it is intended to generate.

Furthermore, the linearity of the circuit may be improved by inserting degeneracy resistors between the reference terminals of the first and second transistors.

As explained previously, the circuit according to the invention will be advantageously coupled to a resonant circuit so as to compensate losses generated by this resonant circuit.

The connexion of the oscillator is done on the bases of transistors T1 and T2. This circuit is relevant since it improves the performances in terms of phase noise, said phase noise being caused by the modulation of the intrinsic noise existing in the active circuit at the resonator level.

The differential pair composed of transistors T1 and T2 defines an amplification system, as well as a conversion system for converting a voltage (on transistors' bases) into a current (at the transistors' collectors).

An important signal to phase noise ratio is obtained since the amplitude of oscillations is important (but not too much for avoiding perturbing the circuit), and that the noise is looped back at the circuit without being amplified.

The invention also relates to an oscillator including an inductive element and a capacitive element arranged for forming a resonant circuit intended to produce a signal that has an oscillation frequency that can be adjusted as a function of the capacitance of the capacitive element, which oscillator further includes an electronic circuit intended to generate a negative conductance as described above, connected to said resonant circuit.

Such an oscillator will deliver a signal that has a large spectral purity, which makes it particularly suitable for use in a tuner which is intended to make a selection of signals at the input of a receiving apparatus such as a television set, a video recorder, a set top box or also a radiotelephone. The invention thus also relates to a receiving apparatus for receiving radio signals, including:

an input stage intended to receive a signal having a radio frequency,

an oscillator intended to produce a signal having an oscillation frequency, and

a mixer intended to produce a signal having an intermediate frequency with a value equal to a difference between the values of the radio frequency and oscillation frequency, in which apparatus said oscillator is the one that has been described above.

These and other aspects of the invention are apparent from and will be elucidated, by way of non-limitative example, with reference to the embodiment(s) described hereinafter.

In the drawings:

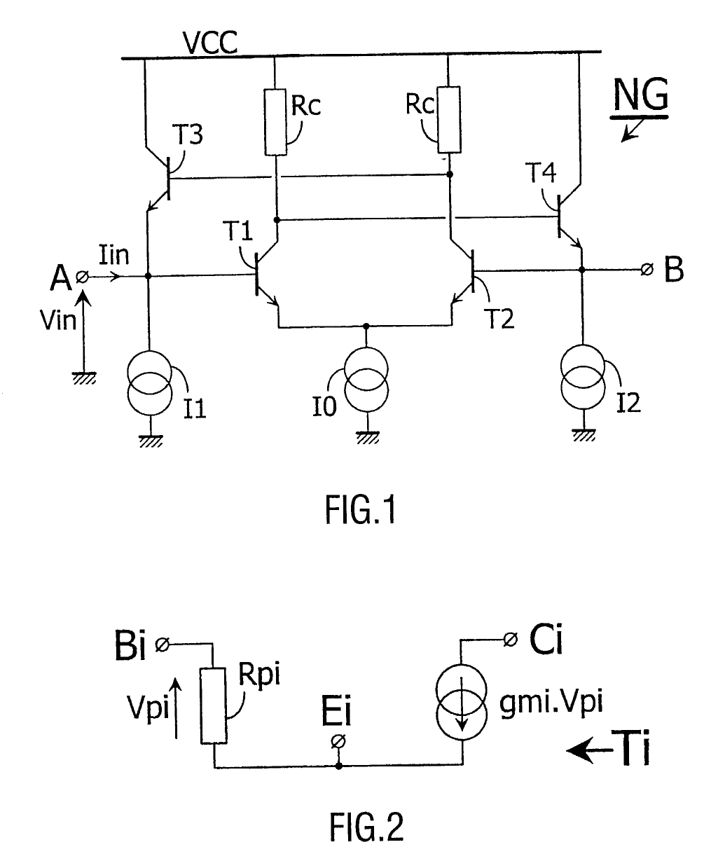

FIG. 1 is an electrical diagram describing an electronic circuit according to an embodiment of the invention,

FIG. 2 is an equivalent diagram as far as small AC signals are concerned of a transistor included in such a circuit,

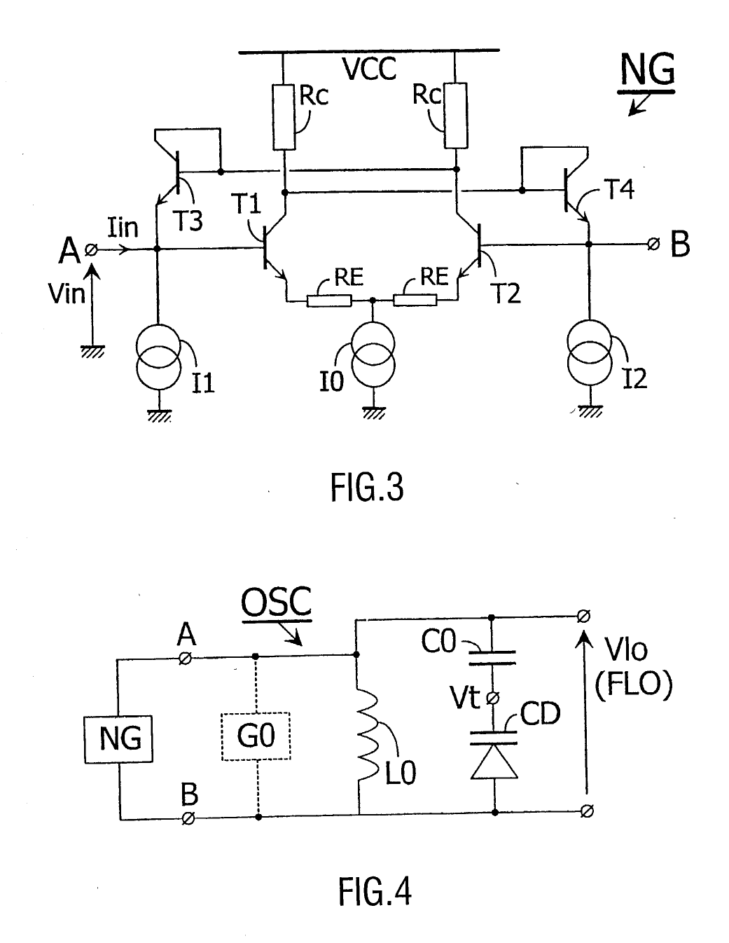

FIG. 3 is an electrical diagram describing an electronic circuit according to a variant of the embodiment of the invention described previously,

FIG. 4 is an electrical diagram describing an oscillator according to a mode of operation of the invention,

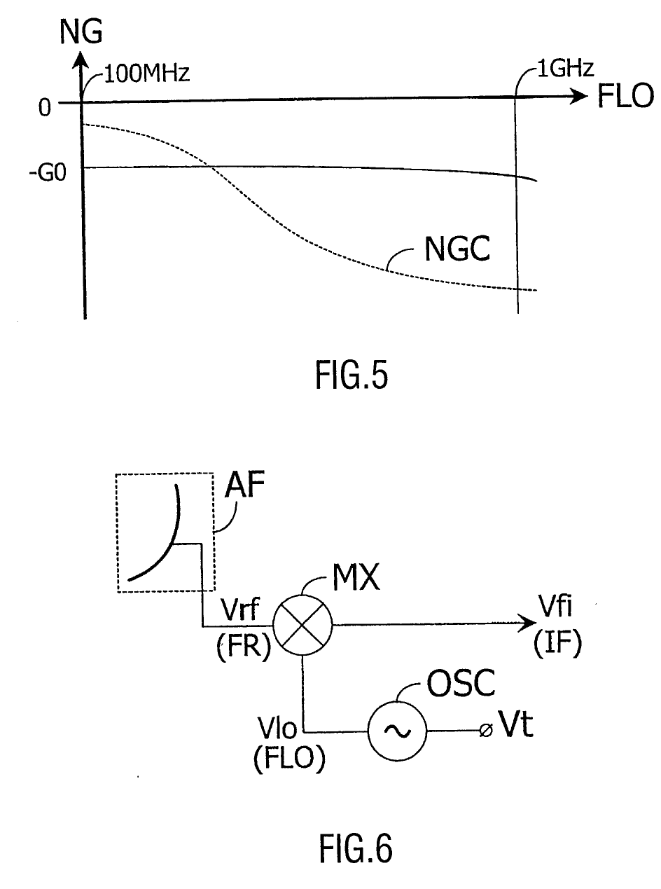

FIG. 5 is a frequency diagram illustrating the substantial invariance of the negative conductance value obtained thanks to the invention, and

FIG. 6 is a functional diagram of a receiving apparatus according to an advantageous mode of operation the invention.

FIG. 1 represents diagrammatically an electronic circuit intended to generate between two connection terminals A and B a negative conductance NG, including a first and a second transistor T1, and T2 connected so as to form a differential pair. These transistors are realized in bipolar technology here and have a base, collector and emitter which respectively form the bias, transfer and reference terminal, respectively. It is suitable in all respects for them to substitute transistors realized in MOS technology, whose MOS transistor gate, drain and source will then form the bias, transfer and reference terminal, respectively.

The bias terminals of the first and second transistors T1 and T2 form the connection terminals A and B of the circuit NG, the transfer terminals of said transistors being connected to a supply terminal VCC via load resistors RC, the reference terminals of the first and second transistors T1 and T2 being together connected to ground of the circuit via a current source I0 intended to bias the differential pair.

The electronic circuit NG further includes a first active element arranged between the bias and transfer terminals of the first and the second transistor T1 and T2, respectively, and a second active element arranged between the bias and transfer terminals of the second and the first transistor T2 and T1, respectively. The first and second active elements are in this example in the form of third and the fourth transistor T3 and T4, respectively, arranged as followers and biased by current sources I1 and I2.

The first and second active elements realize a feedback allowing to bring about the negative current on the bias terminal of the one of the transistors of the differential pair that is the more conducting at a given instant. This negative current permits to generate a negative conductance.

FIG. 2 is an equivalent electrical diagram as far AC signals are concerned which represents a transistor Ti. This transistor Ti has in a first order approximation a resistor Rpi between its base Bi and its emitter Ei, which resistor is intended to generate a voltage Vpi. The transistor Ti further has a current source intended to supply a current of value gmi.Vpi between the collector Ci and the emitter Ei of the transistor Ti, gmi being transconductance of the transistor Ti itself.

This equivalent circuit diagram applied to the circuit represented in FIG. 1 permits to explain the value of the negative conductance NG=Iin/Vin generated by said circuit. This value is written as: NG=(1/Rp3+Rc)[1−Rc.gm2−(Rp3+Rc)/Rp1] and is thus in this first-order approximation independent indeed of the operating frequency of the circuit.

FIG. 3 diagrammatically shows a variant of the circuit described above in which the elements in common with FIG. 1 carry like references and are not described once again. According to this variant the third and fourth transistors T3 and T4 are arranged as a diode, that is to say, their collectors are connected to their bases, which permits to short-circuit the parasitic capacitances are known to exist between the base and the collector of any transistor, although they do not appear in the equivalent circuit diagram described above as a first-order approximation. This permits to improve the linearity of the circuit and the invariance as a function of the operating frequency of said circuit of the negative conductance it is intended to generate. To further improve the linearity of the circuit, degenerating resistors Re have been inserted between the emitters of the first and second transistors T1 and T2. The negative conductance value NG=Iin/Vin generated by this circuit is thus written as: NG=(1/Rp3+Rc)[1−(Rp1/(Rp1+Re)).(Rc.gm2−(Rp3+Rc)/Rp1)], and is always theoretically independent of the operating frequency of the circuit.

FIG. 4 diagrammatically represents a voltage-controlled oscillator OSC intended to produce a signal Vlo which has an oscillation frequency FLO which can be adjusted as a function of the value of a voltage Vt applied to an adjusting terminal of the oscillator. This oscillator OSC includes an inductive element LO and a capacitive element (CO, CD) connected in parallel so as to form a resonant circuit. The capacitive element is in this example formed by a capacitance CO connected in series with a varicap diode CD, a node in between these two elements forming the adjusting terminal. A particularity of the varicap diode is that it has a capacitance with a variable value as a function of its bias voltage, which is here the adjusting voltage Vt. The resonant circuit is thus intended to produce a signal Vlo oscillating at a frequency FLO=(2Π.LO.Ceq)^{1/2}, where Ceq is equal to CO.CD/(CO+CD). The resonant circuit, however, has a parasitic positive conductance GO represented in a dotted line, inherent in the assembly of inductive and capacitive elements which form it, the effect of which is if it is not compensated that it changes the oscillation rate by causing a progressive diminishing of the amplitude of the output signal Vlo, which phenomenon is known by the term of damping. In order to compensate the unwanted effect of this positive parasitic conductance GO, the oscillator OSC further includes a circuit intended to generate a negative conductance NG as described above, which permits a compensation of the losses due to the resonant circuit, which compensation is rendered homogeneous throughout the variation range of the oscillation frequency FLO thanks to the invention. In other applications the inductive and capacitive elements may be connected in series in which case the circuit intended to generate the negative conductance NG will advantageously be connected in series to the series resonant circuit thus formed.

FIG. 5 is a frequency diagram that illustrates this advantage. This diagram represents the evolution of the value of the negative conductance NG generated by the circuit according to the invention, over a range of values of the oscillation frequency FLO running from 100 MHz to 1 GHz, which are values that correspond to those which an oscillator used in a tuner intended for the reception of terrestrial digital signals is to be capable of producing.

It is found that the negative conductance NG obtained thanks to the invention is substantially invariant as a function of the oscillation frequency FLO, with the deviation relative to the theoretical value −GO necessary for perfectly compensating the losses created by the resonant circuit described above being explained by the limitations of the first-order approximation mentioned previously. This deviation is, however, minimum and does not prevent an oscillator with a negative conductance generator circuit according to the invention producing a signal that has an acceptable spectral purity for the greater part of the applications that can be considered in the current state of the art.

By way of comparison a dotted curve NGC represents the evolution of the value of the negative conductance generated with the known assembly, in which the feedback is produced by capacitive elements. The advantages of the invention are well understood by comparing the variations of this curve NGC as a function of frequency with the very small variations of the value of the negative conductance NG obtained thanks to the invention.

More particularly, it is observed that the absolute value of the negative conductance obtained by means of the known assembly significantly increases with the oscillation frequency FLO. This leads to an overcompensation of losses due to the positive conductance intrinsic in the resonant circuit, which overcompensation generates noise and affects the spectral purity of the signal generated by the oscillator including the known assembly.

FIG. 6 illustrates a mode of operation of the invention. This Figure diagrammatically shows a receiving apparatus, for example, a television set, a video recorder, a set top box or also a radiotelephone, including:

an input stage, here an antenna system AF intended to receive a radio signal and to transform this radio signal into an electronic signal Vrf which has a radio frequency FR,

an oscillator OSC as described above, intended to produce a signal Vlo which has an oscillation frequency FLO, and

a mixer MX.

In this apparatus, according to a technique well known to those skilled in the art the mixer produces an output signal Vfi having an intermediate frequency IF of fixed value. As regards the function itself of the mixer, the value of the intermediate frequency IF is equal to the absolute value of a difference between the radio frequency FR and oscillation frequency FLO values, for example IF=FLO−FR if FLO>FR. Thus, the radio frequency FR selected by the adjustment of the oscillation frequency FLO will be equal to FLO−IF. A good definition of the oscillation frequency FLO which is rendered possible on its whole variation range thanks to the invention, will thus permit a large accuracy in the selection of the radio frequency FR.

1. An electronic circuit intended to generate a negative conductance between two connection terminals, including a first and a second transistor connected as a differential pair and having bias terminals which form the connection terminals of the circuit, transfer terminals connected to a supply terminal via load resistors, and reference terminals, which circuit further includes a first active element arranged between the bias terminal and transfer terminal of the first and the second transistor, respectively, and a second active element arranged between the bias terminal and the transfer terminal of the second and the first transistor, respectively.

2. A circuit as claimed in claim 1, in which the first and second active elements are formed by junctions included in the third and fourth transistors.

3. A circuit as claimed in claim 2, in which the third and fourth transistors are arranged as diodes.

4. An oscillator including an inductive element and a capacitive element arranged for forming a resonant circuit intended to produce a signal that has an oscillation frequency which is adjustable as a function of the capacitance of the capacitive element, the oscillator further including a circuit as claimed in claim 1, connected to said resonant circuit.

5. A radio signal receiver apparatus including:
an input stage intended to receive a signal having a radio frequency,
an oscillator intended to produce a signal having an oscillation frequency, and
a mixer intended to produce a signal having an intermediate frequency with a value equal to a difference between the values of the radio frequency and oscillation—frequency, in which apparatus said oscillator is the one as claimed in claim 4.
